(19) United States
(12) Patent Application Publication
(10) Pub. No.: US 2017/0118795 A1
(43) Pub. Date: Apr. 27, 2017

(54) COMMUNICATION SYSTEM, CONTROL NODE, BASE STATION AND METHOD FOR CONGESTION CONTROL ON A BACKHAUL LINK

(71) Applicant: NEC Corporation, Minato-ku, Tokyo (JP)

(72) Inventor: Tao GUO, Woking (GB)

(73) Assignee: NEC Corporation, Minato-ku, Tokyo (JP)

(21) Appl. No.: 15/322,509

(22) PCT Filed: Jun. 10, 2015
(86) PCT No.: PCT/JP2015/067378

§ 371 Date: Dec. 28, 2016

(30) Foreign Application Priority Data
Jul. 11, 2014 (GB) 1412387.1

(51) Int. Cl. H04W 76/06; H04W 72/04; H04W 48/06; H04W 28/26

(52) U.S. Cl. CPC H04W 76/06; H04W 28/26; H04W 72/0413; H04W 72/0486; H04W 48/06

(57) ABSTRACT

A communication system is disclosed that includes a controller node and a base station connected to a core network via at least one communication link. The controller node determines whether communication resources need to be released in order to support communication via the communication link, identifies a base station having reserved communication resources that can be released, and requests the base station to release some of its reserved communication resources whereby to support communication via the communication link.

### TECHNICAL FIELD

The present invention relates to a cellular or wireless telecommunications network, and particularly but not exclusively to alleviation of backhaul congestion in a radio access network. The invention has particular but not exclusive relevance to wireless telecommunications networks implemented according to the Long Term Evolution (LTE) standard specified by the 3rd Generation Partnership Project (3GPP).

### BACKGROUND ART

In 3GPP LTE networks, a base station (i.e. evolved NodeB, eNB) of a Radio Access Network (RAN) transmits data and signalling between a core network (CN) and User Equipment (UEs) located within the base station's coverage area. Base stations of a RAN typically include a number of ‘regular’ or ‘macro’ base stations and a number of ‘small cell’ or ‘pico’ base stations (often referred to as low power nodes, LPNs). In LTE, the RAN is referred to as the Evolved Universal Terrestrial Radio Access (E-UTRA) network (E-UTRAN) and the core network is referred to as the Evolved Packet Core (EPC) network. User equipment may comprise, for example, mobile telephones, mobile communication devices, user communication devices, laptop computers, and/or the like. In the following description the term mobile communication device is used, which is intended to cover any type of such user equipment (mobile and stationary).

In an active or connected state a mobile communication device is registered with the network and has a Radio Resource Control (RRC) connection with a base station so that the network knows to which base station (or cell thereof) the user communication device belongs and can transmit data to and receive data from the user communication device. Each user communication device also establishes a default Evolved Packet System (EPS) Bearer (i.e. an end-to-end dedicated communication path) from the user communication device to an endpoint beyond the base station, typically a gateway (such as a packet data network gateway—‘TDN-GW’ or ‘P-GW’ or the like), in the core network.

An EPS Bearer, which is specific to the mobile communication device, defines a transmission path through the network and assigns an Internet Protocol (IP) address to the mobile communication device, at which it can be reached by other communication devices, such as another UE. An EPS Bearer also has a set of data transmission characteristics, such as quality of service (QoS), data rate and flow control parameters, which are defined by the subscription associated with the mobile communication device and are established by the Mobility Management Entity (MME) upon registration of the mobile communication device with the network. The EPS bearer's set of data transmission characteristics are also associated with any underlying bearers that carry the EPS bearer. Such underlying bearers include, amongst others, a radio bearer (between the mobile communication device and the serving base station) and a transport bearer (between the base station and the core network).

In mobile communication systems (such as LTE systems), a base station may be able to admit high priority bearers and support quality of service (QoS) requirements associated with such high priority bearers even when the base station is operating near or at maximum load. This is achieved by the base station releasing existing low priority bearers, if appropriate, for example when the base station's radio and/or transport network resources are in a highly loaded condition. Such a (‘high’ or ‘low’) priority associated with a particular bearer is referred to as an allocation and retention priority (ARP) in LTE, and the procedures for (the consideration of) the release of bearers is referred to as a pre-emption procedure.

Thus, in case of radio resource limitations in a cell, some (or all) communication bearers with lower priorities may be dropped by the base station operating that cell in order to free up resources required for serving (or admitting) bearers with higher priorities in the cell. The pre-emption decision is done by the base station based on radio load measurements for the cell under consideration. In case of transport resource limitations, the pre-emption decision is done by the base station based on the associated priorities of the in-progress bearers in all the cells sharing a link that is experiencing (and/or causing) a bottleneck. Without such pre-emption in place, high-priority bearers in one cell could be rejected or dropped due to existing lower-priority bearers in other cells of the base station. However, network operators wishing to maximise their revenues set up their base station to admit high-priority bearers as much as possible (even if other, lower priority bearers need to be dropped). Further, it is also necessary to prioritise emergency calls (over other types of calls), which may also require pre-emption at the base station.

The pre-emption procedure may be invoked by the base station either during admission control (AC) or congestion control (CC) execution phase (or both). AC determines whether or not an incoming bearer establishment/modification request can be accepted based on the system capacity (such as the maximum number of allowed concurrent bearers and the total resource usage/load) and the priority and QoS requirements associated with the new bearer to be established/modified. In the AC case, the pre-emption function also determines which bearers need to be pre-empted in order for the new/modified bearer to be allowed. If such pre-emption of existing bearers is not possible, e.g. because there are not enough resources used by lower priority bearers than the new bearer, the establishment/modification of the new bearer is rejected. CC intends to provide a way of reducing the load of the system when the load is too high due to the environment variations (e.g. radio condition change of the base station's microwave links), due to an inaccurate estimation during AC phase, and/or the like. In the CC case, the pre-emption function determines which (lower priority) bearers need to be pre-empted in order to support the QoS requirements of the in-progress higher priority bearers.

However, the above pre-emption procedures, whilst they ensure that each base station is able to prioritise its own bearers, may not always result in an optimal utilisation of the available network resources in the backhaul network connecting the base stations to the core network. This is particularly true for base stations that are coupled to the core network via a plurality of routers (and/or the like) connected via a series of communication links. In this case, the series of communication links between the core network and the base stations may be arranged (e.g. as a branched network topology) such that some of the links may be serving one base station only, whilst other links may be shared between a plurality of base stations (e.g. a number of adjacent/neighbouring base stations and/or a cluster of base stations located in a wider geographical area).

The inventors have realised that in this scenario (e.g. base stations sharing a backhaul network) the prioritisation of bearers by one base station (including any associated pre-emption) may adversely affect the ability of other base stations to support the QoS associated with their own bearers. For example, a base station admitting a new bearer may cause an overload over a link of the backhaul network also utilised by this bearer, even though the base station's own radio/transport bearer load may be low. This in turn may trigger pre-emption procedures at other base stations sharing the backhaul link and hence it may result in a sub-optimal utilisation of the network resources, despite the base station admitting the new bearer being able to prioritise its own bearers as required by the relevant standards.

### SUMMARY OF INVENTION

It is therefore an object of the present invention to improve performance of the communication networks and to improve the ways in which backhaul congestion can be alleviated for base stations sharing a communication link towards the core network.

In one aspect, the invention provides a communication system comprising a controller node and a base station connected to a core network via at least one communication link. The controller node comprises: means for determining whether at least one communication resource needs to be released in order to support communication via the at least one communication link; means for identifying at least one base station having communication resources, reserved for communication via the at least one communication link, that can be released; and

means for sending a request to said at least one identified base station to request release of at least one of said reserved communication resources whereby to support communication via the at least one communication link. The base station comprises: means for receiving, from said controller node, a request to release at least one of said reserved communication resources; and means for releasing, responsive to said received request, at least one communication resource.

In one aspect, the invention provides a controller node for a communication system comprising a base station connected to a core network via at least one communication link, the controller node comprising: means for determining whether at least one communication resource needs to be released in order to support communication via the at least one communication link; means for identifying at least one base station having communication resources, reserved for communication via the at least one communication link, that can be released; and means for sending a request to said at least one identified base station to request release of at least one of said reserved communication resources whereby to support communication via the at least one communication link.

In one aspect, the invention provides a base station connected to a core network via at least one communication link, the base station comprising: means for determining whether at least one communication resource needs to be released in order to support communication via the at least one communication link; means for identifying at least one further base station having communication resources, reserved for communication via the at least one communication link, that can be released; and means for sending a request to said at least one identified further base station to request release of at least one of said reserved communication resources whereby to support communication via the at least one communication link.

In one aspect, the invention provides a base station for a communication system comprising a controller node, and at least one communication link for connecting the base station to a core network, the base station comprising: means for receiving, from the controller node, a request to release at least one communication resource reserved for communication via the at least one communication link; and means for releasing, responsive to said received request, at least one communication resource.

In one aspect, the invention provides abase station comprising: means for communicating with a core network via at least one communication link that supports communication between at least one other base station and said core network; means for obtaining, from a controller node, information representing resource usage over said at least one communication link, including resource usage associated with said at least one other base station; means for receiving a request to admit a bearer over said at least one communication link; means for determining, based on said obtained information representing resource usage over said communication link, whether said bearer should be admitted or rejected; and means for admitting said bearer in dependence on a result of said determination.

In one aspect, the invention provides a method performed in a communication system comprising a controller node and a base station connected to a core network via at least one communication link, the method comprising: at said controller node: determining whether at least one communication resource needs to be released in order to support communication via the at least one communication link; identifying at least one base station having communication resources, reserved for communication via the at least one communication link, that can be released; and sending a request to said at least one identified base station to request release of at least one of said reserved communication resources whereby to support communication via the at least one communication link; and at said base station: receiving, from said controller node, a request to release at least one of said reserved communication resources; and releasing, responsive to said received request, at least one communication resource.

In one aspect, the invention provides a method performed by a controller node in a communication system comprising a base station connected to a core network via at least one communication link, the method comprising: determining whether at least one communication resource needs to be released in order to support communication via the at least one communication link; identifying at least one base station having communication resources, reserved for communication via the at least one communication link, that can be released responsive to a request; and sending a request to said at least one identified base station to request release of at least one of said reserved communication resources whereby to support communication via the at least one communication link.

In one aspect, the invention provides a method performed by a base station in a communication system comprising a controller node, and at least one communication link for connecting the base station to a core network, the method comprising: receiving, from the controller node, a request to release at least one communication resource reserved for communication via the at least one communication link; and releasing, responsive to said received request, at least one communication resource.

In one aspect, the invention provides a method performed by a base station configured to communicate with a core network via at least one communication link that supports communication between at least one other base station and said core network, the method comprising: obtaining, from a controller node, information representing resource usage over said at least one communication link, including resource usage associated with said at least one other base station; receiving a request to admit a bearer over said at least one communication link; determining, based on said obtained information representing resource usage over said communication link, whether said bearer should be admitted or rejected; and admitting said bearer in dependence on a result of said determination.

The invention provides, for all methods disclosed, corresponding computer programs or computer program products for execution on corresponding equipment, the equipment itself (base stations, network controller nodes or components thereof) and methods of updating the equipment.

### BRIEF DESCRIPTION OF DRAWINGS

An exemplary embodiment of the invention will now be described, by way of example, with reference to the accompanying drawings in which:

FIG. 1 schematically illustrates a mobile telecommunication system of a type to which the invention is applicable;

FIG. 2 is a block diagram of a base station suitable for use in the mobile telecommunication system of FIG. 1;

FIG. 3 is a block diagram of a controller node suitable for use in the mobile telecommunication system of FIG. 1;

FIG. 4 is a timing diagram illustrating messages exchanged between elements of the mobile telecommunication system of FIG. 1 whilst carrying out an exemplary embodiment of the invention;

FIG. 5 is a timing diagram illustrating a modification of the exemplary embodiment shown in FIG. 4; and

FIG. 6 schematically illustrates a mobile telecommunication system of a type to which the invention is applicable.

### DESCRIPTION OF EMBODIMENTS

### Overview

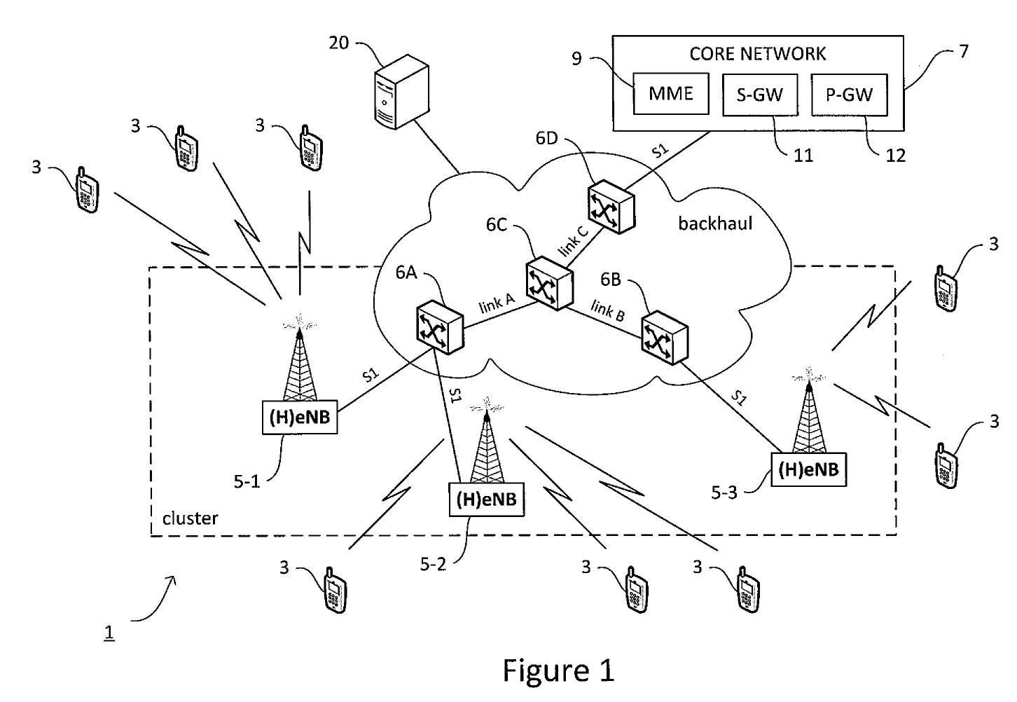

FIG. 1 schematically illustrates a mobile (cellular) telecommunication system 1 including a plurality of mobile communication devices 3 (each of which comprises a mobile telephone or other compatible user equipment) and a plurality of base stations 5-1 to 5-3, each of which operates an associated cell (not shown). Any of the base stations 5-1 to 5-3 may comprise a regular macro eNB and/or a small cell base station (such as Home evolved NodeB (HeNB), pico or femto base station, and/or the like).

In this example, the base stations 5-1 and 5-2 each serve three mobile communication devices 3, and base station 5-3 serves two mobile communication devices 3. As those skilled in the art will appreciate, whilst eight mobile communication devices 3 and three base stations 5 are shown in FIG. 1 for illustration purposes, additional user equipment and/or base stations may be present in a deployed system. It will also be appreciated that each base station 5 may operate more than one cell.

Communication between each of the base stations 5 and a core network 7 is via a so-called ‘S1’ interface, which is provided over a backhaul comprising a number of network routers 6A to 6D. In this example, a communication link A is provided between routers 6A and 6C, a communication link B is provided between routers 6B and 6C, and a communication link C is provided between routers 6C and 6D.

As can be seen, both base stations 5-1 and 5-2 are coupled to the core network 7 via communication links A and C of the backhaul, and the base station 5-3 is coupled to the core network 7 via communication links B and C. In other words, communication link A carries traffic (data and signalling) for two base stations 5-1 and 5-2 (serving a total of six mobile communication devices 3), communication link B carries traffic for a single base station 5-3 (serving two mobile communication devices 3), and communication link C carries traffic for all three base stations 5-1 to 5-3 (and hence for a total of eight mobile communication devices 3).

The core network 7 typically includes, amongst others, a home subscriber server (HSS), a mobility management entity (MME) 9, a serving gateway (S-GW) 11, and a Packet Data Network (PDN) Gateway (P-GW) 12.

Although not shown in FIG. 1, an ‘X2’ interface may also be provided for communication between neighbouring base stations 5 to facilitate data exchange between them (either directly, or via other nodes, such as a small cell gateway, X2 gateway, the backhaul, and/or the like).

Also connected to the backhaul (and hence to the base stations 5 and the core network 7 nodes) is a network controller node 20 (such as a software defined network (SDN) controller, server, and/or the like).

Effectively, the controller node 20 provides a centralised intelligence for the backhaul network by monitoring links A to C (e.g. load conditions thereof) and by optimising the operations of the connected base stations 5 in dependence on the status of the monitored links. It will be appreciated that the controller node 20 is configured to obtain/store information on the backhaul topology, routing, actual load conditions, and information relating to the amount of “pre-emptable” resources for each base station 5 and for each backhaul link A to C on their path.

Therefore, in the system shown in FIG. 1 and using the information available to the controller node 20, pre-emption may be advantageously performed at the AC phase as follows.

When a bearer establishment/modification request arrives at a base station 5, the request (including information identifying the required transport resources) is forwarded to the controller node 20 if all appropriate local (base station specific) checks are passed (e.g. a radio resource usage check and/or the like).

The controller node 20 is configured to decide whether or not the new bearer/bearer modification request can be admitted at this base station 5 based on the load and “pre-emptable” resources of each backhaul link on the path from this particular base station 5 to the core network 7 (e.g. links A and C for base stations 5-1 and 5-2, and links B and C for base station 5-3). The new bearer request is admitted if there are enough resources available over each backhaul link on the path and/or if enough resources can be released (on the path) by performing pre-emption for any congested link (e.g. link C).

If the controller node 20 determines that the new bearer/bearer modification request can be admitted (with or without requiring pre-emption), it sends the decision to the requesting base station 5 so that the base station 5 can proceed with the bearer establishment/bearer modification.

If pre-emption is required, then the controller node 20 also calculates the amount of resources to be released by each base station 5 sharing any congested link(s) (including the requesting base station 5 and other base stations 5). The controller node 20 notifies each base station 5 about the respective amount of resources (e.g. if more than zero) that that base station 5 needs to release in order to accommodate the bearer establishment/modification request.

Beneficially, each base station 5 receiving a resource release request from the controller node 20 is configured to perform an appropriate local pre-emption procedure in order to release the requested amount of resources (even when that base station would not, itself, experience congestion as a result of the bearer admission).

Therefore, in the exemplary system shown in FIG. 1, the controller node 20 may request base station 5-1/5-2 to release some of its resources in order to accommodate a bearer establishment/modification request by base station 5-3, thereby alleviating a potential overload for the link C shared by each base station 5. Similarly, the controller node 20 may request base station 5-2 to release some of its resources in order to accommodate a bearer establishment/modification request by base station 5-1, thereby alleviating a potential overload for link A shared by the base stations 5-1 and 5-2 and for link C shared by each base station 5-1 to 5-3.

Further, in the system shown in FIG. 1 and using the information available to the controller node 20, pre-emption may also be performed at the CC phase. In this case, the controller node 20 is configured to check (e.g. periodically and/or upon receiving a request/trigger) whether any link (e.g. one or more of links A to C) is in (or is potentially in) a congestion state based on associated load information for each backhaul link (e.g. as represented by the resources reserved for that backhaul link) and whether pre-emption is required (and/or allowed) for the (potentially) congested link(s).

Similarly to the AC phase, if pre-emption is required at the CC phase, then the controller node 20 calculates the amount of resources to be released by each base station 5 sharing the congested link(s) and based on information on “pre-emptable” resources of the backhaul links. The controller node 20 then notifies each base station 5 (at least those for which the respective amount to be released is more than zero) about the amount of resources that the base station 5 needs to release in order to alleviate the congestion experienced in the backhaul network (e.g. over links A to C).

Beneficially, each base station 5 receiving a resource release request from the controller node 20 is configured to perform an appropriate local pre-emption procedure in order to release the requested amount of resources, which in turn also reduces the utilisation of the congested link(s) in the backhaul network.

Therefore, in the exemplary system shown in FIG. 1, the controller node 20 may request any of the base stations 5-1 to 5-3 to release some of their resources (by performing an appropriate local pre-emption procedure) in order to alleviate an overload/congestion experienced over a link (or links) between the base stations 5 and the core network 7.

### Pre-Emption Procedure

Before discussing the specific ways in which backhaul congestion can be alleviated in the system shown in FIG. 1, a brief description will be given of the local pre-emption procedure applied by base stations 5 when requested by the controller node 20.

The local pre-emption procedure may be invoked by the controller node 20, when a base station 5 requests a new bearer as part of admission control (AC), or when the controller node 20 determines that the resources reserved for one or more of the backhaul links exceed a predetermined threshold indicative of potential congestion as part of congestion control (CC). AC serves to determine whether an incoming bearer establishment/modification request can be accepted (or should be denied) based on the capacity of the backhaul links required to support the requested bearer (such as the maximum number of allowed concurrent bearers and the total resource usage by existing bearers via that backhaul link), and the priority and QoS requirements associated with the requested bearer.

In the AC case, if pre-emption of sufficient bearers is not possible, the incoming bearer request is rejected (by sending an appropriate response). Otherwise, if the bearer can be admitted, albeit subject to appropriate pre-emption, the incoming bearer request is accepted by the controller node 20. The controller node 20 determines which base stations 5 have existing bearers that can be pre-empted and invokes a local pre-emption procedure at each base station 5 determined to have pre-emptable bearers.

In the CC case, serves to provide a way of reducing/optimising the load on the backhaul links when the load (e.g. as indicated by the reserved resource usage) is (at least temporarily) too high (e.g. exceeds a predetermined threshold). The pre-emption function of the controller node 20 determines which base stations 5 have existing bearers that can be pre-empted (i.e. those base stations having reserved ‘pre-emptable’ resources of a sufficiently low priority to be released) and invokes a local pre-emption procedure at each base station 5 determined to have pre-emptable bearers.

When local pre-emption is triggered the controller node 20 informs the affected base stations 5 of the amount of resources that each base station 5 needs to release to support the QoS requirements of in-progress/newly admitted higher priority bearers (i.e. bearers having a relatively higher priority than the bearers to be pre-empted).

The affected base stations 5 then identify which bearers need to be pre-empted in order to release the requested amount of resources in order to support the QoS requirements of in-progress/newly admitted higher priority bearers.

The bearer level QoS parameters are defined in 3GPP technical specification (TS) 23.401, the contents of which are incorporated herein by reference. As described in TS 23.401, the so-called QoS class identifier ((QCI) controls bearer-level packet forwarding treatment (e.g. by media access control (MAC) level scheduling at the base station 5). Further, in conventional base station controlled pre-emption, the so-called allocation and retention priority (ARP) is used by the base station 5 in its decision whether a particular bearer establishment (or bearer modification) request can be accepted or has to be rejected (e.g. in case of limited resource availability at the base station 5). ARP is also used by the base station 5 in deciding which bearer(s) needs to be dropped during AC and/or CC execution phases. In addition, each guaranteed bit rate (GBR) bearer is additionally associated with a GBR parameter which indicates a bitrate (e.g. minimum/average bitrate) expected for that GBR bearer. A minimum expected throughput may also be also associated with non-GBR bearers.

According to 3GPP TS 36.413, the so-called ‘ARP Pre-emption Capability’ information element (IE) determines whether or not a bearer request is allowed to trigger a pre-emption procedure. Further, the so-called ‘ARP Pre-emption Vulnerability’ IE (associated with a particular bearer) determines whether or not that bearer is allowed to be a candidate for pre-emption (i.e. whether or not that bearer can be pre-empted in favour of other, higher priority bearers). For each bearer, a so-called ‘ARP Priority Level’ IE (having an integer value selected from the range 0 to 15) indicates the priority associated with that bearer. The priority values between 1 and 14 are ordered in decreasing order of priority, i.e. ‘1’ being the highest and ‘14’ the lowest. Value 15 means “no priority”, i.e. the bearer having a priority value of 15 shall not trigger pre-emption and it is not pre-emptable.

In the system shown in FIG. 1, the above described ARP pre-emption capability, the ARP pre-emption vulnerability, and the ARP priority parameters are beneficially used by the controller node 20 in its decision making. For example, the controller node 20 checks, during AC phase, whether a new bearer establishment/modification request is allowed to trigger any pre-emption procedure based on the ARP pre-emption capability associated with that bearer. The controller node 20 may also check, assuming that such bearer specific information is provided by the corresponding base station 5, whether a particular bearer is allowed to be a candidate for pre-emption (in favour of higher priority bearers) during AC and/or CC, based on the ARP pre-emption vulnerability associated with that bearer. The controller node 20 uses the ARP priority parameters and/or QoS parameters associated with the bearers (e.g. the corresponding resource reservations) via the backhaul links in its calculation to determine the amount of resources to be released by each affected base station.

Thus, in case of resource limitations for one or more backhaul links, some bearers with lower ARP priorities via that link may be dropped in order to free up the required resources for the bearers with higher ARP priorities in via the same link. The pre-emption decision is made by the controller node 20 and is implemented by an affected base station 5 based on the amount of resources the controller node 20 request to be released.

### Base Station

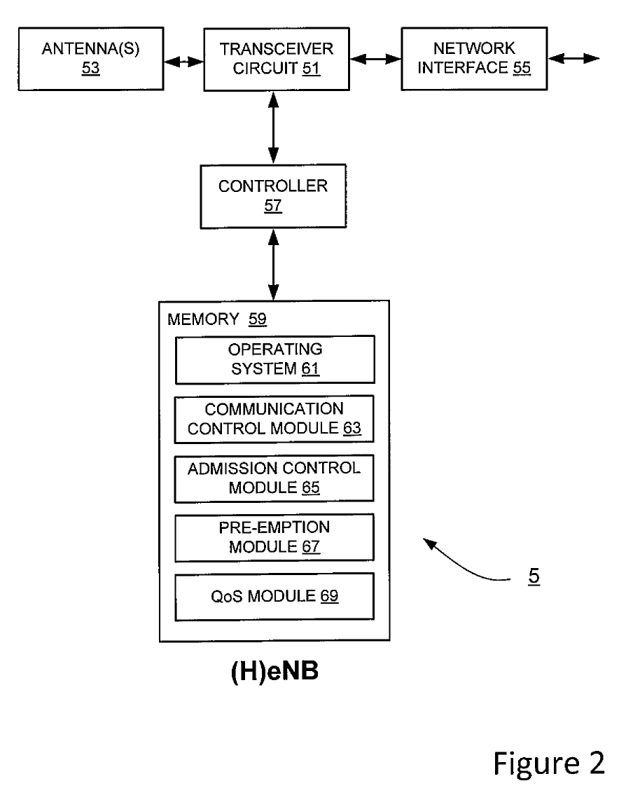

FIG. 2 is a block diagram illustrating the main components of the base stations 5-1 to 5-3 shown in FIG. 1. As shown, the base station 5 includes transceiver circuit 51 which is operable to transmit signals to and to receive signals from the mobile communication devices 3 via one or more antennae 53 and which is operable to transmit signals to and to receive signals from the core network 7 and/or other base stations 5 via a network interface 55. The network interface 55 typically includes an S1 interface for communicating with the core network 7 (via the backhaul) and an X2 interface for communicating with the other base stations. A controller 57 controls the operation of the transceiver circuit 51 in accordance with software stored in memory 59. The software includes, among other things, an operating system 61, a communication control module 63, an admission control module 65, a pre-emption module 67, and a quality of service (QoS) module 69.

The communication control module 63 is operable to control the communication between the base station 5 and the mobile communication devices 3 and to control the communication between the base station 5 and other network entities (e.g. other base stations and core network entities) that are connected to the base station 5. The communication control module 63 also controls the separate flows of uplink and downlink user traffic and control data to be transmitted to the mobile communication devices 3 served by the base station 5 including, for example, control data for managing operation of the mobile communication devices 3.

The admission control module 65 is responsible for the authorisation of establishment of new communication bearers and the authorisation of modification of existing bearers via the base station 5 (for the mobile communication devices 3 served by the base station 5) by performing an appropriate local check (e.g. radio resource usage check). Such local check is performed in response to the admission control module 65 receiving (from a mobile communication device 3 and/or from the MIME 9 serving the mobile communication device 3) a message requesting the base station 5 to initiate a bearer establishment/modification procedure for that mobile communication device 3. As part of this procedure, the admission control module 65 may obtain information from other entities, e.g. the controller node 20, in order to verify whether there is enough capacity available and/or pre-emptable (at the base station 5 and/or at other base stations) to accommodate the bearer establishment/modification for the mobile communication device 3. The admission control module 65 may also communicate with the controller node 20 in order to establish whether pre-emption is required (at this base station 5 and/or another base station) in order to support the QoS associated with the bearer to be established/modified throughout the backhaul network.

The pre-emption module 67 handles the pre-emption procedure when the base station 5 is instructed to release communication resources. The pre-emption module 67 is configured to receive one or more message from the controller node 20 (e.g. via the base station notification module 89 thereof) specifying the amount of resources to be released by the base station 5. In this case, the pre-emption module 67 determines which bearers are the most appropriate candidates for pre-emption, and instructs the communication control module 63 to release such bearers. Alternatively, the controller node 20 may specify exactly which bearers need to be released (e.g. in order to alleviate congestion over a specific link in the backhaul network), in which case the pre-emption module 67 may not need to consider which bearers are the most appropriate candidates for pre-emption.

The QoS module 69 is responsible for ensuring that existing communication bearers provided via the base station 5 (including any newly requested bearers) meet their respective associated quality of service requirements. In order to do so, the QoS module 69 monitors the available capacity and/or current load of the base station 5, including capacity and/or load of the radio bearer (towards the mobile communication devices 3) and the transport bearer (towards the core network 7). The QoS module 69 also maintains information relating to the load conditions and the amount of pre-emptable resources utilised by the base station 5, and provides this information to the controller node 20, as appropriate.

### Controller Node

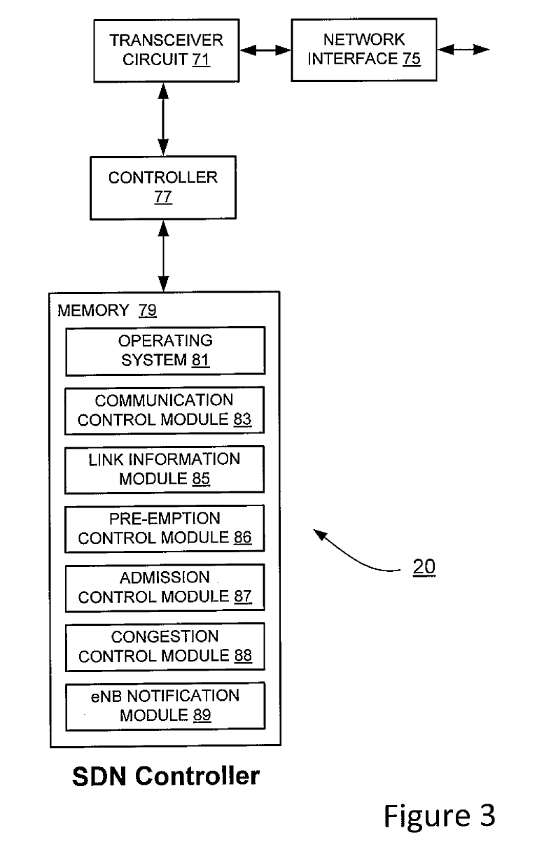

FIG. 3 is a block diagram illustrating the main components of the controller node 20 shown in FIG. 1. As shown, the controller node 20 includes transceiver circuit 71 which is operable to transmit signals to and to receive signals from the core network 7 and/or the base stations 5 via a network interface 75. A controller 77 controls the operation of the transceiver circuit 71 in accordance with software stored in memory 79. The software includes, among other things, an operating system 81, a communication control module 83, a link information module 85, a pre-emption control module 86, an admission control module 87, a congestion control module 88, and a base station (eNB) notification module 89.

The communication control module 83 is operable to control the communication between the controller node 20 and the base stations 5 and/or other network entities (e.g. core network entities) that are connected to the controller node 20 (e.g. via the backhaul).

The link information module 85 obtains (and stores in memory 79) information relating to the communication links (e.g. links A to C of FIG. 1) of the backhaul network, including information relating to the backhaul topology, routing between the base stations 5 and the core network 7, load conditions, and the amount of pre-emptable resources utilised by each base station 5 (e.g. per link) along their path towards the core network 7. It will be appreciated that some or all of this information may be obtained from the base stations 5 themselves (e.g. the QoS modules 69 thereof), the backhaul network (e.g. routers 6), and/or other sources (e.g. an operation and maintenance entity).

The pre-emption control module 86 is responsible for determining (based on information obtained by the link information module 85) whether or not it is necessary (and/or possible) to invoke pre-emption needs for one or more communication links in the backhaul network. When it is determined (e.g. by the admission control module 87/the congestion control module 88) that pre-emption needs to be invoked for one or more communication links, the pre-emption control module 86 calculates the amount of resources each base station utilising that link needs to release in order to alleviate a (potential and/or existing) congestion for the communication link(s) of the backhaul network.

The admission control module 87 is responsible for the authorisation of establishment of new communication bearers and the authorisation of modification of existing bearers via the base stations 5 served by the controller node 20 (using information relating to the communication links, provided by the link information module 85). In order to do so, the admission control module 87 may provide, to each base station 5 (e.g. the admission control module 65 thereof), information relating to each backhaul link used by that base station for its communications with the core network (e.g. information identifying an associated load condition, pre-emptable bearers, and/or the like). Such information may be used by the base stations 5 when carrying out an appropriate admission control, e.g. as part of a bearer establishment/modification procedure.

The admission control module 87 may also receive (from a serving base station 5) a message requesting the initiation of a bearer establishment/modification procedure for a mobile communication device 3. In this case, the admission control module 87 may obtain information from the link information module 85 in order to verify whether there is enough capacity available and/or pre-emptable (at the base stations 5 served by the controller node 20) to accommodate the requested bearer establishment/modification. If the requested bearer establishment/modification can be accommodated, and if pre-emption is needed, the admission control module 87 generates and sends a message, to each base station 5 having communication resources that should be pre-empted, requesting the base station 5 to carry out an appropriate local pre-emption in order to support the QoS associated with the bearer to be established/modified. The admission control module's 87 message includes information (obtained from the pre-emption control module 86) identifying the amount of resources that that particular base station 5 needs to release.

The congestion control module 88 is responsible for alleviating congestion in the backhaul network, e.g. by determining whether one or more communication bearers (provided via the backhaul links) should be pre-empted. If pre-emption is needed, the congestion control module 88 generates and sends a message, to each base station 5 having communication resources that should be pre-empted, requesting the base station 5 to carry out an appropriate local pre-emption in order to alleviate the congestion in the backhaul network. The congestion control module's 88 message includes information (obtained from the pre-emption control module 86) identifying the amount of resources that that particular base station 5 needs to release.

The base station notification module 89 handles (generates, sends, and receives) messages exchanged with the base stations 5, including messages requesting the base stations 5 to perform a pre-emption procedure (as determined by the pre-emption control module 86).

In the above description, the base station 5 and the controller node 20 are described for ease of understanding as having a number of discrete modules such as the communications control modules, the pre-emption module, and the pre-emption control module). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

### Operation

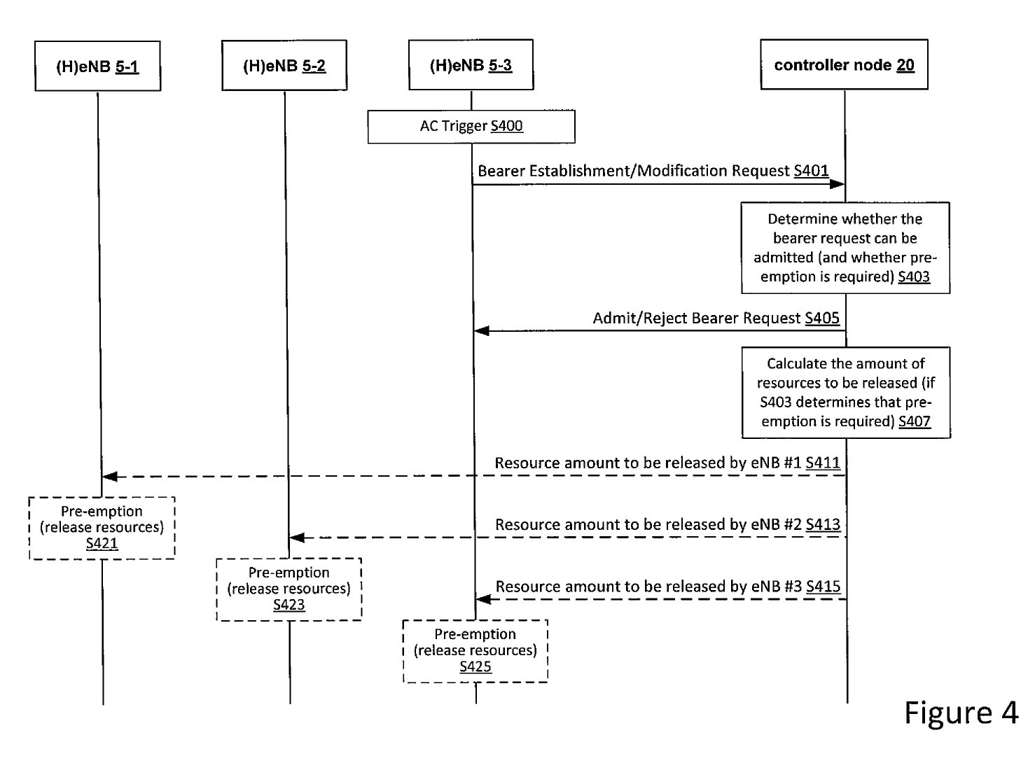

FIG. 4 is a timing diagram illustrating messages exchanged between elements of the mobile telecommunication system of FIG. 1 whilst carrying out an exemplary embodiment of the present invention.

As can be seen, the procedure starts in step S400, in which the base station 5-3 initiates admission control procedures relating to a bearer establishment/bearer modification request received at the base station 5-3.

The base station 5-3 (using its admission control module 65) thus generates and sends, in step S401, an appropriately formatted message (e.g. a ‘Bearer Establishment Request’ or ‘Bearer Modification Request’ RRC message) requesting the controller node 20 to determine whether the bearer establishment/bearer modification request received at the base station 5-3 can be proceeded with.

In step S403, the controller node 20 (using its link information module 85/admission control module 87) determines whether the bearer request can be admitted at the base station 5-3. The controller node 20 (using its pre-emption control module 86) also determines whether any pre-emption is required in relation to the bearer request.

As shown in step S405, the controller node 20 (using its eNB notification module 89) generates and sends an appropriately formatted signalling message notifying the base station 5-3 whether to admit or reject the bearer (establishment/ modification) request.

Next, as generally shown in step S407, the controller node 20 (using its pre-emption control module 86) calculates the amount of resources (if any) that needs to be released by each base station 5 sharing at least one backhaul link (e.g. in this case link C) with the bearer being established/modified via base station 5-3.

If the controller node's 20 calculation indicates that pre-emption is needed (i.e. at least one base station 5 needs to release a non-zero amount of resources due to the newly admitted bearer establishment/modification), then the controller node 20 proceeds to the next step. Otherwise (e.g. if pre-emption is not needed/not possible/not enabled) the current procedure terminates at S407.

As generally shown in steps S411 to S415, the controller node 20 (using its eNB notification module 89) generates and sends appropriately formatted signalling messages to each base station 5 that shares at least one backhaul link (e.g. link C) with the bearer being established/modified via base station 5-3, and that needs to release a non-zero amount of resources due to the newly admitted bearer establishment/modification.

Thus, if base station 5-1 needs to release resources, the controller node 20 indicates the amount of resources to be released by this base station 5-1, at step S411. In response to the controller node's 20 message, the base station 5-1 (using its pre-emption module 67) proceeds to perform an appropriate (local) pre-emption procedure, at step S421, thereby releasing at least the amount of resources requested by the controller node.

If base station 5-2 or 5-3 also needs to release resources, based on the calculations at S407, an appropriate pre-emption can be requested by the controller node 20 at step S413 and S415, respectively, which would be complied with by the base stations 5-2 and 5-3 at steps S423 and S425, respectively.

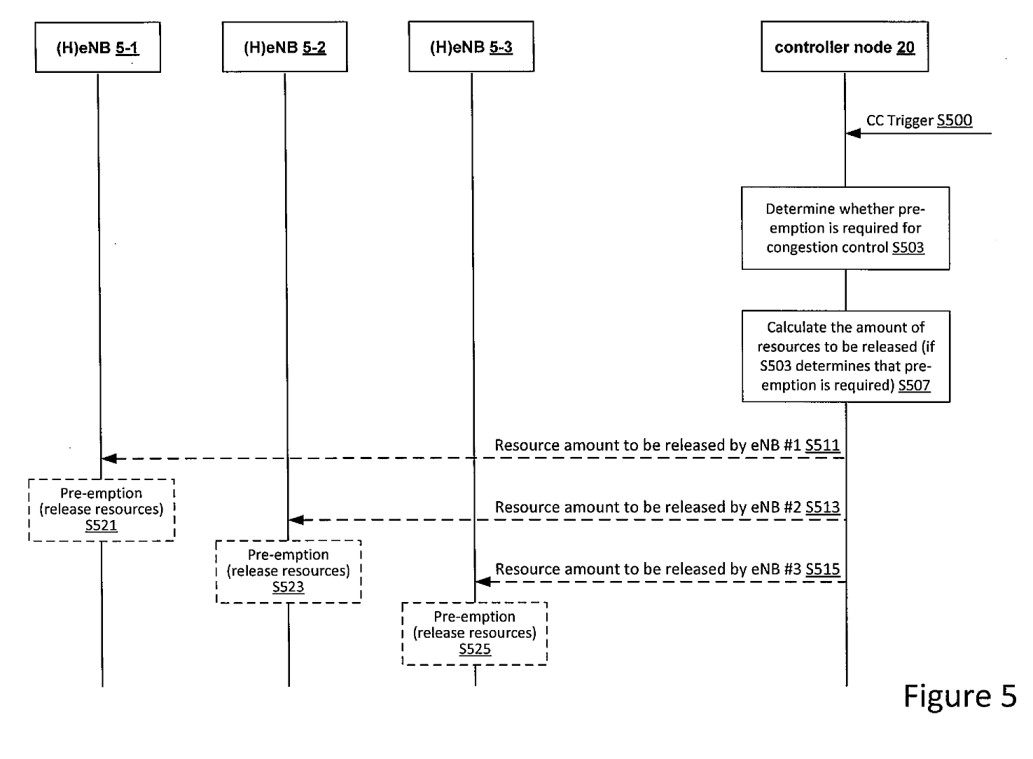

FIG. 5 is a timing diagram illustrating a modification (or a subsequent operation) of the exemplary embodiment shown in FIG. 4. In this case, the base stations 5 and the controller node 20 are configured to perform pre-emption in response to a congestion control trigger.

In this case, the procedure starts in step S500, in which the controller node 20 (using its congestion control module 88) receives a trigger to initiate congestion control procedures with respect to at least one of the links A to C of the backhaul network. For example, the link information module 85 may determine that link C is congested and provide an appropriate indication to the congestion control module 88.

Therefore, in step S503, the controller node 20 (using its link information module 85/congestion control module 88) determines whether any pre-emption is required/possible in order to address the congestion that triggered the procedure. Next, as generally shown in step S507, the controller node 20 (using its pre-emption control module 86) calculates the amount of resources (if any) that needs to be released by each base station 5 sharing the congested backhaul link C.

If the controller node's 20 calculation (at S507) indicates that pre-emption is needed (i.e. at least one base station 5 needs to release a non-zero amount of resources) and/or possible (i.e. there are pre-emptable resources via the link C), then the controller node 20 proceeds to the next step. Otherwise (e.g. if pre-emption is not needed/not possible/not enabled for link C) the current procedure terminates at S507.

Steps S511 to S525 correspond to steps S411 to S425 described above with reference to FIG. 4, therefore their discussion is omitted here for simplicity.

### IMPLEMENTATION EXAMPLE

It will be appreciated that the above described general framework and procedures for co-ordinated pre-emption to address backhaul congestion may be implemented using a number of methods, depending on how the load and “pre-emptable” resource amount associated with a backhaul link are defined in the network and how the base stations 5 are selected by the controller node for pre-empting bearers.

The following is a description of an exemplary implementation of the above exemplary embodiments in the system shown in FIG. 1. It will be appreciated that in a deployed network there may be multiple paths between a base station 5 and the core network 7, e.g. via multiple P-GWs and/or via various backhaul networks, which is usually determined by means of traffic engineering/optimisation.

However, there is usually a single path connecting a small cell base station (e.g. a HeNB) to a macro site base station (eNB), in which case the HeNB and the eNB are configured to share at least some backhaul links. For simplicity of description, it is assumed that all bearers of a particular base station 5 traverse the same path although the implementation example can be also extended to cover the case of multiple paths by recording the bearer information on a per-path basis.

### Link Slate Updating

For each backhaul link k (e.g. links A to C in FIG. 1), the controller node 20 is configured to maintain (using its link information module 85) a set Nₖ including the identities of all the base stations 5 sharing that particular backhaul link. The controller node 20 is configured to monitor the load of each backhaul link k (e.g. in percentage):

$${ρ}_{k} = \frac{{\sum }_{n ∈ {N}_{k}}^{ } {total\_r}_{n}}{{b}_{k}}$$

where bₖ is the bandwidth of backhaul link k and total_rₙ is the sum of the required bitrates of all the bearers that belong to eNB n (base station n).

The controller node 20 is also configured to record (using its link information module 85) the required bitrates of the “pre-emptable” bearers of each eNB n for each ARP priority value j, Rₙ[j].

Each base station 5 and/or by the MME 9 is configured to report the values of total_rₙ and Rₙ [j] either periodically or when triggered by certain events (e.g. congestion, bearer establishment/modification, and/or the like). Let rₙ[i] denote the required bitrate of bearer i at eNB n. They can be described as:

$${total\_r}_{n} = {\sum }_{i}^{ } {r}_{n} [ i ]$$

$${R}_{n} [ j ] = {\sum }_{{ARP ( i ) = j}_{i is pre \text{-} emptable}}^{ } {r}_{n} [ i ]$$

The controller node 20 is thus able to calculate the sum of the required bitrates of the “pre-emptable” bearers belonging to the base stations 5 sharing the backhaul link k, for each ARP priority value j (1≦j≦14):

$${sum\_R}_{k} [ j ] = {\sum }_{n ∈ {N}_{k}}^{ } {R}_{n} [ j ]$$

### AC Pre-Emption Trigger

When a bearer establishment/modification request i* (with ARP priority value j*, required bitrate rₙ[i*] is received from eNB n, the request is admitted immediately if the following condition is satisfied (for both downlink and uplink):

bₖ·ρₖ+rₙ[i*]≦bₖ·σₖ^{AC}, (∀k∈Lₙ)

where Lₙ denotes the set of all the backhaul links on the path of eNB n and σₖ^{AC} represents an associated AC threshold for backhaul link k (in percentage). Otherwise, the set of congested links is constructed as Cₙ={k: k∈Lₙ, bₖ·ρₖ+rₙ[i*]>bₖ·σₖ^{AC}} and the controller node 20 checks whether the following condition is satisfied:

$${b}_{k} \cdot {ρ}_{k} + {r}_{n} [ {i}^{*} ] - {\sum }_{{j}^{*} + 1 \leq j \leq 14}^{ } {sum\_R}_{k} [ j ] \leq {b}_{k} \cdot {σ}_{k}^{A C} , ( ∀ k ∈ {C}_{n} )$$

If this condition is satisfied, the incoming bearer request is admitted and the pre-emption execution procedure is triggered by the controller node 20. Otherwise, the incoming bearer request is rejected by the controller node 20 (e.g. using its eNB notification module 89).

### CC Pre-Emption Trigger

CC pre-emption is triggered if the following condition is satisfied (for downlink and/or uplink) for at least one backhaul link k:

ρₖ>σₖ^{CC}

where σₖ^{CC} is a CC threshold associated with backhaul link k (in percentage). In this case, the set of congested links is constructed as Cₙ={k: ρₖ>σₖ^{CC}}.

### Pre-Emption Execution at the Controller Node

If the pre-emption execution procedure is triggered (e.g. at step S400 of FIG. 4 or step S500 of FIG. 5), either by the controller node 20 or by another node (such as the MME 9 or one of the base stations 5), it will be appreciated that the controller node 20 may be configured to perform (using its pre-emption control module 86) the following steps:

(1) The controller node 20 initialises jₙ=14 and ΔRₙ=0 for each eNB n∈∪_{k∈C}_{ₙ} Nₖ. For each eNB n, all the bearers with ARP priority value greater than jₙ are to be released (assuming they are pre-emptable), and ΔRₙ is the resource amount to be released for ARP priority value jₙ.

(2) For each k∈Cₙ, the controller node 20 calculates the total resource amount to be released:

Δtotal_rₖ=bₖ·ρₖ+rₙ, [i*]−bₖ·σₖ^{AC}(AC)

Δtotal_rₖ=bₖ·ρₖ−bₖ·σₖ^{CC} (CC)

(3) For each k∈Cₙ, if Δtotal_rₖ≦0, the controller node 20 removes k from Cₙ. If Cₙ=Ø, then the controller node 20 proceeds to step (13); otherwise, it proceeds to step (4).

(4) For each k∈Cₙ, the controller node 20 calculates the resource amount to be released per ARP priority value j:

$${Δsum\_R}_{k} [ j ] = max ( 0 , min ( {Δtotal\_r}_{k} - {\sum }_{j + 1 \leq j ′ \leq 14}^{ } {sum\_R}_{k} [ {j}^{′} ] , {sum\_R}_{k} [ j ] ) )$$

(5) For each k∈Cₙ, the controller node 20 finds the lowest j value satisfying Δsum_Rₖ[j]>0, jₖ^{min}.

(6) The controller node 20 selects k*=arg min_{k∈C}_{ₙ}{jₖ^{min}}. If there are multiple links satisfying this condition, the one with the largest Δsum_Rₖ[jₖ^{min}] is selected.

(7) The controller node 20 sets jₙ=jₖ^{min} for each eNB n∈N_{k*}.

(8) The controller node 20 creates a temporary list including all eNB n∈Nₖ* with Rₙ[jₙ]>0. The controller node 20 sets a ‘temporary’ parameter ΔR′ₙ=0 for each eNB in the list.

(9) The controller node 20 sorts the temporary list in decreasing order of Σ_{k∈C}_{ₙ} I(n∈Nₖ) value where I(*) is an indication function with the value being set to 1 if the condition * in the bracket is satisfied and set to ‘0’ otherwise. The eNBs that have the same Σ_{k∈C}_{ₙ} I(n∈Nₖ) value are sorted in decreasing order of their associated Rₙ[jₙ] value.

(10) The controller node 20 removes the first element n from the temporary list. If Rₙ[jₙ]≦Δsum_Rₖ[jₙ], then the controller node 20 sets ΔR′ₙ=Δsum_Rₖ[jₙ] and proceeds to step (11); otherwise, the controller node 20 sets ΔR′ₙ=Rₙ[jₙ] and Δsum_Rₖ[jₙ]=Δsum_Rₖ[jₙ]−Rₙ[jₙ] and then repeats step (10).

(11) The controller node 20 updates total_rₙ and Rₙ[j] (jₙ≦j≦14) in order for each eNB n∈N_{k*}

$${total\_r}_{n} = {total\_r}_{n} - {ΔR}_{n}^{′} - {\sum }_{{j}_{n} + 1 \leq j \leq 14}^{ } {R}_{n} [ j ]$$

$${R}_{n} [ j ] = \{ \begin{matrix}0 , & j \geq {j}_{n} + 1 \\ {R}_{n} [ j ] - {ΔR}_{n}^{′} , & j = {j}_{n}\end{matrix}$$

The controller node 20 updates ρₖ and sum_Rₖ[j] accordingly, for each backhaul link k that that particular eNB n traverses, and updates ΔRₙ=ΔRₙ+ΔR′ₙ.

(12) The controller node 20 removes k* from Cₙ. If Cₙ=Ø, then the controller node 20 proceeds to step (13); otherwise, it proceeds to step (2).

(13) The controller node 20 sends the pre-emption request (e.g. as shown in steps S411 to 415 of FIG. 4, and in steps S511 to 515 of FIG. 5) with jₙ and ΔRₙ to each eNB n that has at least one bearer (non-zero amount of resources) to be released.

The rationale behind the above procedure is that since a base station 5 (i.e. a bearer thereof) may contribute to the congestion of multiple links (e.g. links also used by other base stations), the controller node 20 is configured to consider the topology relationship of the network when deciding which base stations 5 are selected for pre-emption, thereby minimising the number of bearers that need to be released.

A numerical example is given below considering the scenario illustrated in FIG. 1. In this example, the bandwidths of backhaul link A, link B, and link C are 100 Mbps, 100 Mbps, and 200 Mbps, respectively. The load threshold for each link is set to 80%. For simplicity, in this example it is assumed that all bearers are “pre-emptable”. Therefore, the “pre-emptable” resources of each base station 5 for each ARP priority value Rₙ[j] are given in Table 1 below.

TABLE 1
pre-emptable resources (units: Mbps)

| | ARP | | | | | | | | | | | | | |
|---|---|---|---|---|---|---|---|---|---|---|---|---|---|---|
| ID | 1 | 2 | 3 | 4 | 5 | 6 | 7 | 8 | 9 | 10 | 11 | 12 | 13 | 14 |
| eNB | 0 | 0 | 10 | 0 | 0 | 10 | 0 | 5 | 0 | 5 | 5 | 10 | 0 | 5 |
| 1 | | | | | | | | | | | | | | |
| eNB | 5 | 0 | 0 | 0 | 5 | 0 | 5 | 0 | 10 | 10 | 0 | 5 | 10 | 0 |
| 2 | | | | | | | | | | | | | | |
| eNB | 0 | 10 | 10 | 0 | 10 | 0 | 10 | 0 | 5 | 0 | 10 | 5 | 10 | 10 |
| 3 | | | | | | | | | | | | | | |

Thus, the load of link A, link B and link C are 100% (=(50(eNB 1)+50(eNB 2))/100*100), 80% (=80(eNB 3)/100*100) and 90% (=(50(eNB 1)+50(eNB2)+80(eNB 3))/200*100) respectively. Since link A and link C are considered to be congested, i.e. Cₙ={link A, link C}, CC pre-emption is triggered (e.g. as shown in step S500 of FIG. 5).

The sum_Rₖ[j] (i.e. the sum of the required bitrates of the “pre-emptable” bearers) is calculated for each link as shown in Table 2 below.

TABLE 2
sum of bitrates of pre-emptable bearers (units: Mbps)

| | ARP | | | | | | | | | | | | | |
|---|---|---|---|---|---|---|---|---|---|---|---|---|---|---|
| ID | 1 | 2 | 3 | 4 | 5 | 6 | 7 | 8 | 9 | 10 | 11 | 12 | 13 | 14 |
| Link | 5 | 0 | 10 | 0 | 5 | 10 | 5 | 5 | 10 | 15 | 5 | 15 | 10 | 5 |
| A | | | | | | | | | | | | | | |
| Link | 0 | 10 | 10 | 0 | 10 | 0 | 10 | 0 | 5 | 0 | 10 | 5 | 10 | 10 |
| B | | | | | | | | | | | | | | |
| Link | 5 | 10 | 20 | 0 | 15 | 10 | 15 | 5 | 15 | 15 | 15 | 20 | 20 | 15 |
| C | | | | | | | | | | | | | | |

When the pre-emption is executed, the total resource amount to he released at link A and link C are calculated as 20 Mbps and 20 Mbps respectively in order to reduce the load of each to 80% (or lower), i.e. Δtotal_rₖ=20 Mbps for both link A and link C.

The resource amounts to be released per ARP priority value at each congested link (Δsum_Rₖ[j]) are calculated as shown in Table 3 below.

TABLE 3
resource amounts to be released per ARP value (units: Mbps)

| | ARP | | | | | | | | | | | | | |
|---|---|---|---|---|---|---|---|---|---|---|---|---|---|---|
| ID | 1 | 2 | 3 | 4 | 5 | 6 | 7 | 8 | 9 | 10 | 11 | 12 | 13 | 14 |
| Link | 0 | 0 | 0 | 0 | 0 | 0 | 0 | 0 | 0 | 0 | 0 | 5 | 10 | 5 |
| A | | | | | | | | | | | | | | |
| Link | 0 | 0 | 0 | 0 | 0 | 0 | 0 | 0 | 0 | 0 | 0 | 0 | 5 | 15 |
| C | | | | | | | | | | | | | | |

Since link A has the lowest j value satisfying Δsum_Rₖ[j]>0 (i.e. 12), link A is selected for processing first. In step (8), a temporary list including base station 5-1 and base station 5-2 is constructed. In step (9), the list is ordered as {eNB 5-1, eNB 5-2} since Σ_{k∈C}_{ₙ} I(n∈Nₖ)=2 for both of them but R₁[12]>R₂[12]. It is decided (e.g. as part of step S507 of FIG. 5) that 5 Mbps bearers with ARP 12 should be released from base station 5-1. Thus, after step (12), we have j₁=12, j₂=12, ΔR₁=5 Mbps and ΔR₂=0 Mbps, and link A is removed from Cₙ. When step (2) is repeated, the total resource amount to be released at link C is 0 since 20 Mbps have been released when processing link A. Thus, all bearers of base station 5-3 are allowed to go through link C. The final sum_Rₖ[j] after implementing the pre-emption procedure is shown in Table 4 below.

TABLE 4
updated sum of bitrates of pre-emptable bearers (units: Mbps)

| | ARP | | | | | | | | | | | | | |
|---|---|---|---|---|---|---|---|---|---|---|---|---|---|---|
| ID | 1 | 2 | 3 | 4 | 5 | 6 | 7 | 8 | 9 | 10 | 11 | 12 | 13 | 14 |
| Link | 5 | 0 | 10 | 0 | 5 | 10 | 5 | 5 | 10 | 15 | 5 | 10 | 0 | 0 |
| A | | | | | | | | | | | | | | |
| Link | 0 | 10 | 10 | 0 | 10 | 0 | 10 | 0 | 5 | 0 | 10 | 5 | 10 | 10 |
| B | | | | | | | | | | | | | | |
| Link | 5 | 10 | 20 | 0 | 15 | 10 | 15 | 5 | 15 | 15 | 15 | 15 | 10 | 10 |
| C | | | | | | | | | | | | | | |

It is worth mentioning that from the perspective of a single base station, the bearers with lower priority should always be dropped first before any bearer with higher priority is dropped, however, it is not always true from the perspective of a single backhaul link (e.g. link C) to avoid the bearers being unnecessarily dropped.

### Pre-Emption Execution at the Base Stations

When a base station 5 (eNB n) receives a pre-emption request from the controller node 20 with jₙ and ΔRₙ, it will be appreciated that the base station (using its pre-emption module 67) may be configured to perform the following steps:

(1) The base station 5 adds all the “pre-emptable” bearers with the ARP priority value j′>jₙ to Bearers_To_Be_Dropped list.

(2) If ΔRₙ>0, then the base station 5 proceeds to step (3); otherwise, it proceeds to step (7) below.

(3) The base station 5 creates a temporary list including all the “pre-emptable” bearers of the base station (eNB n) with ARP priority value jₙ.

(4) The base station 5 sorts the temporary list in decreasing order of the required bitrate.

(5) If the temporary list is non-empty, then the base station 5 proceeds to step (6); otherwise, it proceeds to step (7).

(6) The base station 5 removes the first element (with required bitrate rₙ[i]) from the temporary list and adds it to Bearers_To_Be_Dropped list. If rₙ[i]≧ΔRₙ, then the base station 5 proceeds to step (7); otherwise, it sets ΔRₙ=ΔRₙ−rₙ[i] and then proceeds to step (5).

(7) The base station 5 releases all the bearers included in its Bearers To Be Dropped list.

### MODIFICATIONS AND ALTERNATIVES

A number of detailed exemplary embodiments have been described above. As those skilled in the art will appreciate, a number of modifications and alternatives can be made to the above exemplary embodiments whilst still benefiting from the inventions embodied therein. By way of illustration only a number of these alternatives and modifications will now be described.

In the above exemplary embodiments, a mobile telephone based telecommunication system was described. As those skilled in the art will appreciate, the techniques described in the present application can be employed in any communication system. In the general case, the base stations and the mobile communication devices can be considered as communications nodes or devices which communicate with each other. Other communications nodes or devices may include access points and user devices such as, for example, personal digital assistants, laptop computers, web browsers, and the like.

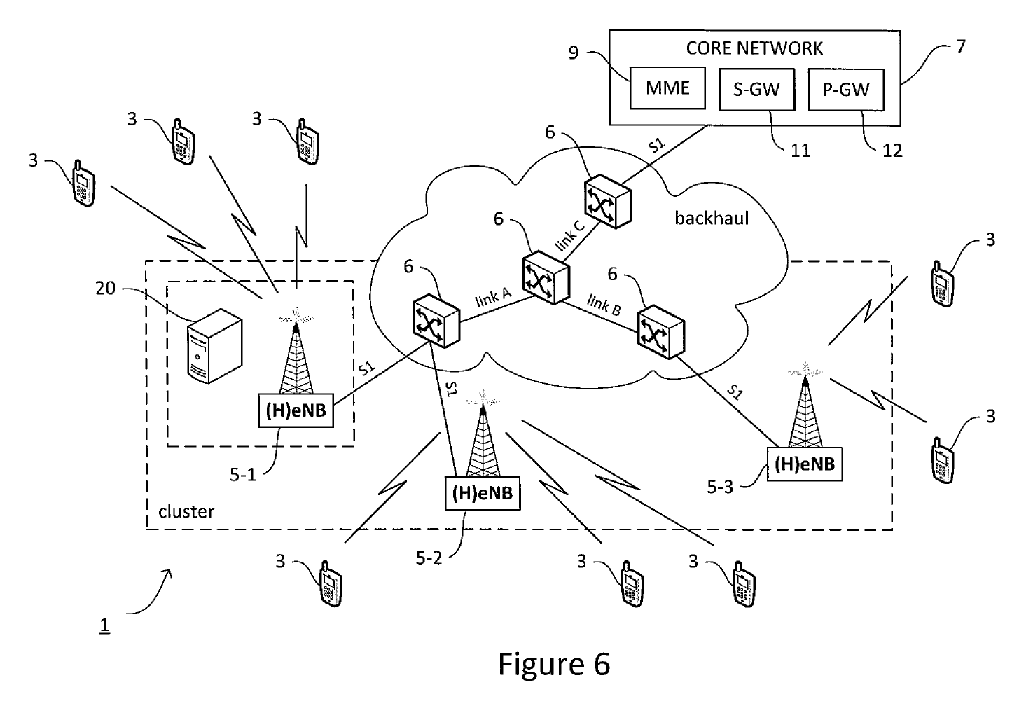

In the above exemplary embodiments, the controller node is described to be connected to the backhaul network. It will be appreciated that the functionalities of the controller node may be implemented by one of the base stations (e.g. the base station 5-1 of FIG. 6) and/or a local entity (e.g. a gateway) within (or connected to) a cluster comprising a plurality of base stations. It will be appreciated that a cluster of base stations (as generally illustrated in FIG. 1) may be constructed based on the backhaul topology relationship and/or based on other criteria (e.g. type/range/manufacturer of the base station and/or the like). Alternatively, a cluster may include all base stations in the network (e.g. all LTE base stations). It will be appreciated that the node controlling the cluster may monitor the local network conditions and control any pre-emption for all base stations in its cluster.

It will be appreciated that step S405 of FIG. 4 may be performed only after step S407 (and possibly after steps S411 to S425). This would beneficially ensure that an admitted bearer establishment/modification is not performed at the requesting base station until any required pre-emption procedure has been completed.

The above exemplary embodiments describe pre-emption in case of backhaul congestion in a specific network topology. However, it will be appreciated that the proposed methods may be applicable regardless of the physical media used in the backhaul (e.g. microwave link, optical fibre links, and/or the like) and/or any kind backhaul topology (e.g. hub & spoke, Daisy chain, etc.).

For simplicity of descriptions, this invention does not differentiate between downlink and uplink processing. However, it will be appreciated that the proposed methods may be applicable selectively to downlink, uplink, or both. For example, an incoming bearer request may be accepted only if both downlink and uplink resource requirements are satisfied. It will be appreciated that CC may be triggered by either downlink or uplink resource shortage.

Whilst the above exemplary embodiments are described using base stations (eNBs) as examples, the proposed methods are also applicable to home base stations (HeNBs) connected to a backhaul (either directly or via a gateway and/or the like).

In a variation of the procedure described with reference to FIG. 4, each base station receives (from the controller node 20) information identifying the current load and the amount of “pre-emptable” resources for each backhaul link on the base station's own path towards the core network. In this case, upon processing an incoming bearer request, the base station can determine (based on the received information) whether the request can be admitted or not. This beneficially reduces the time it takes for the network to process a bearer establishment/modification request as there is no need to involve the controller node whenever a new request is received. In this case, the base station may be configured to send a resource release request to the controller node only if pre-emption at another base station is needed. The controller node may be configured to calculate the resource amount to be released by each base station sharing the congested links and trigger local pre-emption at the corresponding base station(s).

In another variation of the procedure described with reference to FIG. 4, each base station receives (from the controller node 20) information identifying the current load for each backhaul link on the base station's own path towards the core network. In this case, upon processing an incoming bearer request, the base station may be configured to admit the request immediately if the backhaul load check is passed (based on the received load information). In this case, the base station may be configured to send a resource release request to the controller node only if the backhaul load check fails for the new request. The controller node may be configured to determine whether the bearer request can be admitted or not and notify the requesting eNB accordingly. The controller node may also be configured to calculate the resource amount to be released by each base station sharing the congested links and trigger local pre-emption at the corresponding base station(s). This variation may beneficially reduce the overall processing time of bearer requests when the backhaul is not congested while reducing signalling load compared to the previous variation.

In the above exemplary embodiments, the controller node is described to decide on pre-emption by taking into account the load of each backhaul link. In the above examples, the “load” of a backhaul link is described to be determined based on the total resource reservations (for each priority level) for that backhaul link. However, it will be appreciated that the load of a backhaul link may be determined based on information identifying an actual (measured, rather than estimated) usage of the backhaul link provided by either abase station or a router associated with that backhaul link. Such information identifying an actual usage of a link may include, for example, information identifying the number of active bearers vs. the total number of allowed bearers over a backhaul link, the amount of resources used vs. the total available resources over a backhaul link, an indication of overload, an indication of an actual (e.g. measured) load being over an associated load threshold for that backhaul link, and/or the like.

In the above exemplary embodiments, a number of software modules were described. As those skilled will appreciate, the software modules may be provided in compiled or un-compiled form and may be supplied to the base station and/or the controller node as a signal over a computer network, or on a recording medium. Further, the functionality performed by part or all of this software may be performed using one or more dedicated hardware circuits. However, the use of software modules is preferred as it facilitates the updating of the base station and/or the controller node in order to update its functionality. Similarly, although the above embodiments employed transceiver circuitry, at least some of the functionality of the transceiver circuitry can be performed by software.

The controller node might comprise means for receiving a request to admit a bearer over said at least one communication link; means for determining whether said bearer should be admitted or rejected; and said means for determining whether at least one communication resource needs to be released may be operable to determine that at least one resource needs to be released responsive to a determination, by said means for determining whether said bearer should be admitted or rejected, that said bearer should be admitted.

The means for identifying may be operable to identify at least one base station that is different to a base station via which the requested bearer is to be provided.

The controller node may comprise means for determining that a communication link is potentially congested; and said means for determining whether at least one communication resource needs to be released may be operable to determine that resources are to be released responsive to a determination, by said means for determining that a communication link is potentially congested, that a communication link is potentially congested. The means for identifying may be operable to determine the amount of resources to be released by each identified base station having communication resources that can be released; and the means for sending a request may be operable to send a request to each identified base station that indicates the respective amount of resources determined by the means for identifying for that identified base station.

The means for identifying may be operable to identify at least one base station that has reserved communication resources having a lower priority than other communication resources reserved for communication via said communication link.

The request to release at least one of said reserved communication resources may comprise a request to pre-empt communication resources. The at least one communication link may comprise at least one backhaul link. The controller node may comprise a gateway.

The base station may comprise means for sending, to said controller node, a request to admit a bearer over said at least one communication link.

The base station may further comprise means for determining, prior to said admitting means admitting said bearer, whether at least one communication resource needs to be released in order to support communication via the at least one communication link; and means for sending a request to said controller node to request release of said at least one communication resource.

Various other modifications will be apparent to those skilled in the art and will not be described in further detail here.

This application is based upon and claims the benefit of priority from United Kingdom patent application No. 1412387.1, filed on Jul. 11, 2014, the disclosure of which is incorporated herein in its entirety by reference.

1. (canceled)

2. A controller node for a communication system comprising a base station connected to a core network via at least one communication link, the controller node comprising:
at least one processor configured to:
determine whether at least one communication resource needs to be released in order to support communication via the at least one communication link;
identify at least one base station having communication resources, reserved for communication via the at least one communication link, that is releasable; and
send a request to said at least one identified base station to request release of at least one of said reserved communication resources whereby to support communication via the at least one communication link.

3. The controller node according to claim 2, wherein the at least one processor is further configured to:
receive a request to admit a bearer over said at least one communication link;
determine whether said bearer should be admitted or rejected; and
determine that at least one resource needs to be released responsive to a determination that said bearer should be admitted.

4. The controller node according to claim 3, wherein the at least one processor is further configured to identify at least one base station that is different to a base station via which the requested bearer is to be provided.

5. The controller node according to claim 2, wherein the at least one processor is further configured to:
determine that a communication link is potentially congested; and
determine that resources are to be released responsive to a determination that a communication link is potentially congested.

6. The controller node according to claim 2, wherein:
the at least one processor if further configured to:
determine the amount of resources to be released by each identified base station having communication resources that is releasable; and
send a request to each identified base station that indicates the respective amount of resources determined.

7. The controller node according to claim 2, wherein the at least one processor is further configured to identify at least one base station that has reserved communication resources having a lower priority than other communication resources reserved for communication via said communication link.

8. The controller node according to claim 2, wherein said request to release at least one of said reserved communication resources comprises a request to pre-empt communication resources.

9. The controller node according to claim 2, wherein said at least one communication link comprises at least one backhaul link.

10. The controller node according to claim 2, comprising a gateway.

11. A base station connected to a core network via at least one communication link, the base station comprising:
at least one processor configured to:
determine whether at least one communication resource needs to be released in order to support communication via the at least one communication link;
identify at least one further base station having communication resources, reserved for communication via the at least one communication link, is releasable; and
send a request to said at least one identified further base station to request release of at least one of said reserved communication resources whereby to support communication via the at least one communication link.

12-16. (canceled)

17. A method performed by a controller node in a communication system comprising a base station connected to a core network via at least one communication link, the method comprising:
determining whether at least one communication resource needs to be released in order to support communication via the at least one communication link;
identifying at least one base station having communication resources, reserved for communication via the at least one communication link, that is releasable responsive to a request; and
sending a request to said at least one identified base station to request release of at least one of said reserved communication resources whereby to support communication via the at least one communication link.

18-19. (canceled)

20. A non-transitory computer implementable instructions product comprising computer implementable instructions for causing a programmable communications device to perform the method according to claim 17.
